(19) United States
(12) Patent Application Publication
(10) Pub. No.: US 2011/0310137 A1
(43) Pub. Date: Dec. 22, 2011

(54) Image Display Device

(76) Inventors: Kenta Kajiyama, Yotsukaido (JP); Takeshi Izumida, Mobara (JP); Naoki Tokuda, Mobara (JP); Hajime Akimoto, Kokubunji (JP)

(21) Appl. No.: 13/163,149

(22) Filed: Jun. 17, 2011

(30) Foreign Application Priority Data
Jun. 22, 2010 (JP) 2010-142098

(51) Int. Cl. G09G 5/10

(52) U.S. Cl. 345/690

(57) ABSTRACT

The present invention provides an image display device comprising data lines each supplying a data signal, and a plurality of pixel circuits. Each of the pixel circuits includes a light-emitting element, a capacitor which stores a difference in potential caused by the data signal therein, a drive transistor which has a gate electrode connected to the data line via the capacitor and controls light emission of the light-emitting element based on a difference in potential between the gate electrode and a source electrode thereof, which is generated by a potential supplied by the data line and the potential difference stored in the capacitor, and a variation control switch which causes the difference in potential between the gate and source electrodes of the drive transistor to vary based on the data signal at the turning on thereof and prevents the difference in potential from varying at the turning off thereof.

### CLAIM OF PRIORITY

The present application claims priority from Japanese Patent Application JP 2010-142098 filed on Jun. 22, 2010, the content of which is hereby incorporated by reference into this application.

### BACKGROUND OF THE INVENTION

1. Field of the Invention

The present invention relates to an image display device, and particularly to an image display device using light-emitting elements.

2. Description of the Related Art

The development of an image display device using light-emitting elements such as an organic EL display device or the like has recently been carried out actively. The image display device using the light-emitting elements adopts a drive method for separating periods, from each other, including a period (write period) for causing a capacitor included in each of a plurality of pixel circuits to store a difference in potential indicative of an emitted amount of light, and a period (light emission period) for causing each of the pixel circuits to emit light.

FIG. 16 is a circuit diagram showing one example of a circuit configuration of a pixel circuit included in a conventional image display device. A plurality of pixel circuits are included in the image display device, but the present drawing shows one of them and wirings connected to the pixel circuit. The wirings include a data line DAT, a power supply line PWR, a reset switch control line RES, and an illumination control switch control line ILM. The data line DAT and the power supply line PWR extend in the vertical direction as viewed in the drawing. The reset switch control line RES and the illumination control switch control line ILM extend in the horizontal direction as viewed in the drawing. The pixel circuit includes a light-emitting element IL, a drive transistor TRD, a capacitor CP, a lighting or illumination control switch SWI, and a reset switch SWR. The drive transistor TRD is a pMOS thin film transistor. A gate electrode of the drive transistor TRD is connected to the data line DAT via the capacitor, a source electrode thereof is connected to the power supply line PWR, and a drain electrode thereof is connected to one end of the light-emitting element IL via the illumination control switch SWI. The other end of the light-emitting element IL is connected to a wiring for supplying a reference potential such as a ground potential. The reset switch SWR is provided between the drain and gate electrodes of the drive transistor TRD. Incidentally, the reset switch SWR and the illumination control switch SWI are thin film transistors respectively. A gate electrode of the reset switch SWR is connected to the reset switch control line RES. A gate electrode of the illumination control switch SWI is connected to the illumination control switch control line ILM.

A drive method used in the image display device will be explained. During a write period, a data signal is sequentially supplied to a plurality of pixel circuits connected to the same data line, a control signal based on a write operation is supplied to a control line for a given pixel row of a plurality of pixel rows, and a difference in potential corresponding to the data signal is stored in its corresponding capacitor included in each pixel circuit supplied with the control signal. In the pixel circuit supplied with the control signal, the reset switch SWR and the illumination control switch SWI are first turned on and a data signal indicative of an emitted amount of light is supplied from the data line DAT, so that the electric charge held in the capacitor CP is reset. Then, the illumination control switch SWI is turned off, so that a potential difference on which the data signal and the threshold voltage Vth of the drive transistor TRD are reflected, occurs in the capacitor CP. After that, the reset switch SWR is turned off so that the difference in potential is stored in the capacitor CP. This operation is performed on each pixel circuit. After differences in potential are stored in their corresponding capacitors CP included in all the pixel circuits in the image display device, the illumination control switches SWI included in the plural pixel circuits are turned on and potentials for light emission periods are supplied from their corresponding data lines DAT, so that the drive transistors TRD cause currents corresponding to gradations represented by data signals to flow to light-emitting elements, and the light-emitting elements IL emit light with brightness corresponding to the data signals. JP-A-2003-122301 has been disclosed an example of the above image display device.

### SUMMARY OF THE INVENTION

When a hysteresis characteristic exists in a drive transistor TRD included in a given pixel circuit, hysteresis occurs due to a data signal for storing a difference in potential in each of capacitors CP included in other pixel circuits connected to the same data line, so that the threshold voltage Vth of the drive transistor TRD varies. Thus, the difference between the threshold voltage Vth at the storage of the difference in potential in the capacitor CP (at writing) and the threshold voltage Vth at the time of light emission varies according to the data signal for other pixel circuits, thus resulting in degradation of image quality such as unevenness in the emitted amount of light.

The present invention has been made in view of the above problems. An object of the present invention is to provide an image display device capable of suppressing a fluctuation in the difference between a threshold voltage Vth at writing and a threshold voltage Vth at light emission, which occurs due to a data signal for other pixel circuits connected to the same data line.

Summary of typical ones of the inventive aspects of the invention disclosed in this application will be briefly described as follows:

(1) There is provided an image display device comprising data lines each supplying a data signal, and a plurality of pixel circuits, each of the plurality of pixel circuits including a light-emitting element, a capacitor which stores a difference in potential caused by the data signal therein, a drive transistor which has a gate electrode connected to the data line via the capacitor and controls light emission of the light-emitting element, based on a difference in potential between the gate electrode and a source electrode thereof, the difference in potential being caused by a potential supplied by the data line and the potential difference stored in the capacitor, and a variation control switch which causes the difference in potential between the gate and source electrodes of the drive transistor to vary based on the data signal at the turning on thereof and prevents the difference in potential from varying at the turning off thereof.

(2) In the image display device according to (1), the variation control switch and the capacitor both included in each of the pixel circuits are disposed in series between the data line and the gate electrode of the drive transistor included in the pixel circuit.

(3) In the image display device according to (2), the gate electrode of the drive transistor and the capacitor both included in each of the pixel circuits are connected to each other via the variation control switch included in the pixel circuit.

(4) In the image display device according to (1), the data line supplies a potential for light emission to each of the gate electrodes of the drive transistors included in the pixel circuits during a light emission period different from a period for supplying the data signal for causing each of the capacitors included in the pixel circuits to store the difference in potential, and the drive transistor included in each of the pixel circuits controls light emission of the light-emitting element included in each of the pixel circuits, based on the difference in potential between the gate and source electrodes thereof, the difference in potential being caused by the potential for light emission and the potential difference stored in the capacitor.

(5) In the image display device according to (2), the gate electrode of the drive transistor and the variation control switch both included in each of the pixel circuits are connected to each other via the capacitor included in the pixel circuit.

(6) In the image display device according to (2), one end of the variation control switch included in each of the pixel circuits is connected to the source electrode of the drive transistor, the other end of the variation control switch being supplied with a power supply potential.

(7) There is provided an image display device comprising data lines each supplying a data signal, and a plurality of pixel circuits, each of the plurality of pixel circuits including a light-emitting element, a capacitor which has one end connected to the data line and stores a difference in potential caused by the data signal therein, a variation control switch having one end connected to the other end of the capacitor, a drive transistor which has a gate electrode connected to the other end of the variation control switch and performs control on light emission of the light-emitting element based on a potential supplied by the data line and the potential difference stored in the capacitor, an illumination control switch having one end connected to one end of the light-emitting element and the other end connected to a drain electrode of the drive transistor, and a reset switch having one end connected to the gate electrode of the drive transistor and the other end connected to the drain electrode of the drive transistor.

(8) There is provided an image display device comprising data lines each supplying a data signal, a plurality of pixel circuits, and a power supply line, each of the plurality of pixel circuits including a light-emitting element, a first capacitor which has one end connected to the data line and stores a difference in potential caused by the data signal therein, a drive transistor which has a gate electrode connected to the other end of the first capacitor and performs control on light emission of the light-emitting element based on a potential supplied by the data line and the potential difference stored in the first capacitor, an illumination control switch having one end connected to one end of the light-emitting element, the other end of the illumination control switch being connected to a drain electrode of the drive transistor, a reset switch having one end connected to the gate electrode of the drive transistor and the other end connected to the drain electrode of the drive transistor, a second capacitor which has one end connected to the gate electrode of the drive transistor and the other end connected to a source electrode of the drive transistor, the second capacitor storing a difference in potential caused by the data signal therein, and a variation control switch having one end connected to a power supply line and the other end connected to the source electrode of the drive transistor.

According to the present invention, an image displace device is capable of suppressing a fluctuation in the difference between a threshold voltage Vth at writing and a threshold voltage Vth at light emission, which occurs due to a data signal for other pixel circuits connected to the same data line.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing one example of a circuit configuration of an organic EL display device according to an embodiment of the present invention;

FIG. 2 is a circuit diagram illustrating one example of a configuration of each pixel circuit in the organic EL display device shown in FIG. 1;

FIG. 3 is a waveform diagram depicting changes in potentials supplied to an integrated data line, a variation control switch control line HYS, a reset switch control line RES, and an illumination control switch control line ILM;

FIG. 4 is a waveform diagram showing changes in potentials of RGB switch control lines, a variation control switch control line, a reset switch control line and an illumination control switch control line, during a given horizontal scanning period;

FIG. 5A is a diagram illustrating the states of respective switches of a pixel circuit with no writing of a data signal during a write period;

FIG. 5B is a diagram depicting the states of respective switches of a pixel circuit in which the writing of a data signal is being conducted during a write period;

FIG. 5C is a diagram showing the states of respective switches of a pixel circuit in which the writing of a data signal is being performed during a write period;

FIG. 5D is a diagram illustrating the states of respective switches of a pixel circuit in which the writing of a data signal is being conducted during a write period;

FIG. 5E is a diagram showing the states of respective switches of a pixel circuit during a light emission period;

FIG. 6 is a diagram illustrating a hysteresis characteristic of a p-channel type thin film transistor;

FIG. 7 is a diagram showing a change in the amount of current with time, which flows where a pulse signal is applied to a gate electrode of the p-channel type thin film transistor;

FIG. 8 is a diagram depicting an example of a pattern of an image displayed on the organic EL display device;

FIG. 9 is a waveform diagram showing changes in data line potential and threshold voltages at points A and B in a conventional organic EL display device;

FIG. 10 is a waveform diagram illustrating changes in data line potential and threshold voltages at points A′ and B′ in the conventional organic EL display device;

FIG. 11 is a waveform diagram showing changes in data line potential and threshold voltages at points A and B in the organic EL display device according to the present embodiment;

FIG. 12 is a waveform diagram depicting changes in data line potential and threshold voltages at points A′ and B′ in the organic EL display device according to the present embodiment;

FIG. 13 is a diagram showing another example of a pixel circuit of the organic EL display device according to the embodiment of the present invention;

FIG. 14 is a diagram illustrating a further example of a pixel circuit of the organic EL display device according to the embodiment of the present invention;

FIG. 15 is a diagram depicting a yet another example of a pixel circuit of the organic EL display device according to the embodiment of the present invention; and

FIG. 16 is a circuit diagram showing one example of a configuration of a conventional pixel circuit.

### DESCRIPTION OF THE PREFERRED EMBODIMENTS

An embodiment of the present invention will hereinafter be described based on the accompanying drawings. The same reference numerals are respectively attached to those having the same function in components that appear therein, and the description thereof is omitted. Incidentally, a description will be made below of a case where the present invention is applied to an organic EL display device that is a kind of an image display device using light-emitting elements.

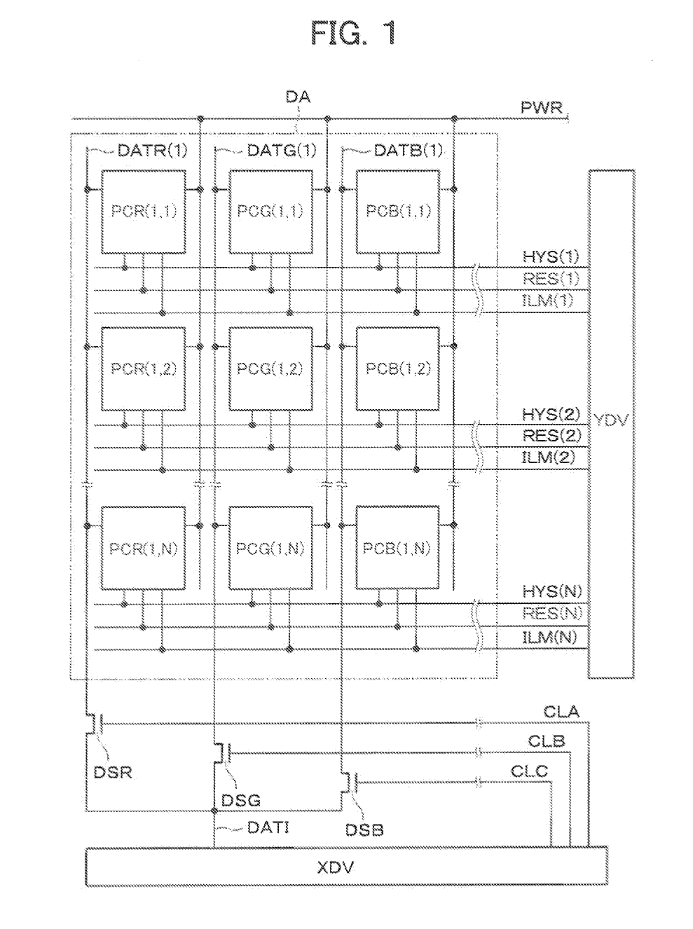

FIG. 1 is a diagram showing one example of a circuit configuration of an organic EL display device according to the embodiment of the present invention. The organic EL display device physically includes an array substrate, a flexible printed circuit board, and a driver integrated circuit encapsulated in a package. A display area DA for displaying an image is disposed on the array substrate. Circuits shown in FIG. 1 are principally provided in the array substrate and the driver integrated circuit. The display area DA is provided on the array substrate of the organic EL display device, and pixels are disposed in the display area DA in matrix form. Three pixel circuits PCR, PCG and PCB are respectively disposed in areas serving as pixels side by side in the horizontal direction in the drawing. The pixel circuit PCR includes a light emitting element that emits red light and displays the red. The pixel circuit PCG includes a light emitting element that emits green light and displays the green. The pixel circuit PCB includes a light emitting element that emits blue light and displays the blue. When the pixel circuits are not distinguished in type from each other, they are hereinafter called “pixel circuits PC”. Incidentally, pixels of M columns×N rows are disposed in the display area DA. Incidentally, a pixel circuit PCR that configures pixels of an nth row and an mth column is described as PCR (m, n). A green pixel circuit PCG is described as PCG (m, n). A blue pixel circuit PCB is described as PCB (m, n). Pixel circuits PC of (3×M) columns×N rows are arranged side by side in the display area. In the present embodiment, the pixel circuits PC aligned in the same column display the same color.

Further, data lines DATR, DATG and DATB (hereinafter called data lines DAT when no distinction is made between these data lines), and a power supply line PWR respectively extend vertically as viewed in the drawing within the display area DA so as to correspond to the respective columns of the pixel circuits PC. Rest switch control lines RES, illumination control switch control lines ILM and variation control switch control lines HYS respectively extend in the horizontal direction as viewed in the drawing in association with the respective rows of the pixel circuits PC. RGB changeover switches DSR, DSG and DSB provided corresponding to the data lines DATR, DATG and DATB, an integrated data line DATI, a data line drive circuit XDV, and a vertical scanning circuit YDV are provided in an area which serves as an area provided on the array substrate and is located outside the display area DA. Incidentally, parts of the data line drive circuit XDV and the vertical scanning circuit YDV are provided even in the driver integrated circuit.

The pixel circuits PC connected to the same data line DAT display the same color. Subsequently, a data line DATR corresponding to a column of pixel circuits PCR that configures a column of pixels of an mth column is described as DATR (m), a data line DATG corresponding to a column of pixel circuits PCG is described as DATG (m), and a data line DATB corresponding to a column of pixel circuits PCB is described as DATB (m). A given data line DAT supplies a data signal to a plurality of pixel circuits PC lying within its corresponding column. The numbers of reset switch control lines RES, illumination control switch control lines ILM and variation control switch control lines HYS are respectively the same number (N) as the number of rows of pixel circuits PC. The reset switch control line RES, illumination control switch control line ILM and variation control switch control line HYS corresponding to the row of the pixel circuits of the nth row are respectively described as RES (n), ILM (n) and HYS (n). Each one ends of the reset switch control line RES, illumination control switch control line ILM and variation control switch control line HYS are connected to the vertical scanning circuit YDV. A power supply line PWR that supplies power to the respective pixel circuits PC is provided within the display area DA.

The RGB changeover switches DSR, DSG and DSB are thin film transistors and are provided m corresponding to the columns of pixels respectively. An RGB changeover control line CLA is connected to its corresponding gate electrode of the RGB changeover switch DSR. An RGB changeover control line CLB is connected to its corresponding gate electrode of the RGB changeover switch DSG. An RGB changeover control line CLC is connected to its corresponding gate electrode of the RGB changeover switch DSB.

One end of the RGB changeover switch DSR is connected to the lower end of the data line DATR (m), corresponding to each pixel circuit PCR, of the data lines DAT corresponding to the mth column of pixels. The other end of the RGB changeover switch DSR is connected to one end of an integrated data line DATI, corresponding to pixels of an mth column, of integrated data lines DATI which are provided M corresponding to columns of pixels. Likewise, the lower end of the data line DATG (m) is connected to one end of the corresponding integrated data line DATI via the RGB changeover switch DSG. The lower end of the data line DATB (m) is connected to one end of the corresponding integrated data line DATI via the RGB changeover switch DSB. The other end of the integrated data line DATI is connected to the data line drive circuit XDV.

Incidentally, drain electrodes of the RGB changeover switches DSR, DSG and DSB are connected to the integrated data line DATI, whereas source electrodes thereof are connected to their corresponding data lines DAT. Incidentally, the source and drain electrodes of each thin film transistor are determined depending on the direction of current flowing through the thin film transistor and whether the thin film transistor is an n or p-channel type. The thin film transistor itself has no polarity. Thus, the destination to which the source electrode is connected, and the destination to which the drain electrode is connected, may be reversed.

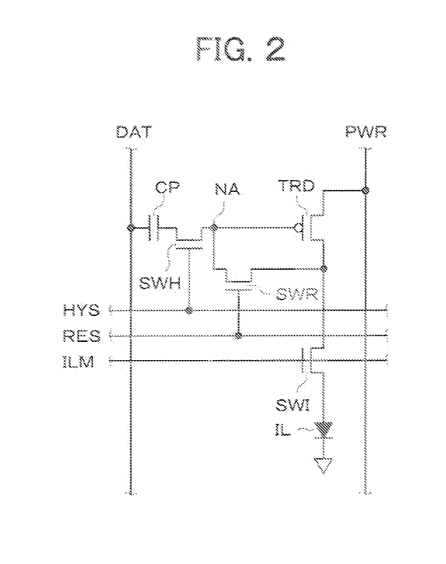

FIG. 2 is a circuit diagram showing one example of a configuration of each pixel circuit PC. The pixel circuit PC includes a light-emitting element IL, a drive transistor TRD, a capacitor CP, an illumination control switch SWI, a reset switch SWR, and a variation control switch SWH. A reference potential is supplied to one end of the light-emitting element IL by an unillustrated reference potential supply line. One end of the capacitor CP is connected to a data line DAT corresponding to the pixel circuit PC. A gate electrode of the drive transistor TRD is connected to the other end of the capacitor CP via the variation control switch SWH. A source electrode of the drive transistor TRD is connected to a power supply line PWR, and a drain electrode thereof is connected to one end of the illumination control switch SWI. The other end of the illumination control switch SWI is connected to the other end of the light-emitting element IL. The gate and drain electrodes of the drive transistor TRD are connected to each other through the reset switch SWR. The drive transistor TRD is a p-channel type thin film transistor, and the illumination control switch SWI, reset switch SWR and variation control switch SWH are respectively n channel type thin film transistors. A gate electrode of the illumination control switch SWI is connected to an illumination control switch control line ILM corresponding to the pixel circuit PC. A gate electrode of the reset switch SWR is connected to a reset switch control line RES corresponding to the pixel circuit PC. A gate electrode of the variation control switch SWH is connected to a variation control switch control line HYS. A node to which the gate electrode of the drive transistor TRD is connected is called a node NA.

Incidentally, the reference potential is a potential defined as a reference from a relationship with a power supply potential supplied from the power supply line PWR and potentials supplied to the data line DAT, the illumination control switch control line ILM and the variation control switch SWH. The reference potential may not always be supplied from a grounded electrode.

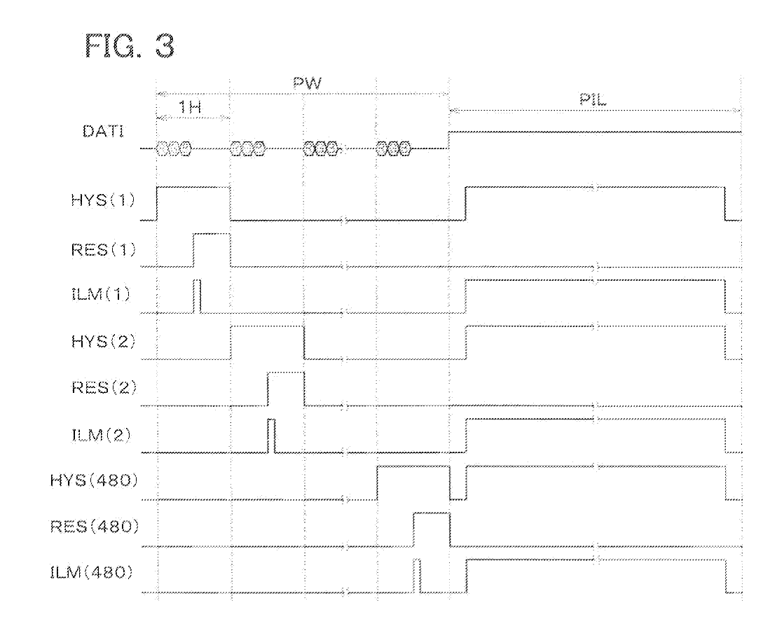

A method for driving the image display device according to the present embodiment will next be explained. FIG. 3 is a waveform diagram showing changes in potentials supplied to the integrated data line DATI, variation control switch control line HYS, reset switch control line RES, and illumination control switch control line ILM. A description will be made below assuming that the number of rows of pixels is 480. The present drawing shows a potential of an integrated data line DATI and changes in potentials during one frame period, of variation control switch control lines HYS (1), HYS (2) and HYS (480), reset switch control lines RES (1), RES (2) and RES (480) and illumination control switch control lines ILM (1), ILM (2) and ILM (480). The one frame period is separated into a write period PW and an illumination or light emission period PIL. During the write period PW, the operation (hereinafter referred to as writing of a data signal into each pixel circuit PC) of causing each of capacitors included in pixel circuits PC of rows to store a difference in potential based on a data signal for every row of the pixel circuits PC is performed. A period during which the writing of a data signal into each pixel circuit PC of one row is performed is called a horizontal scanning period 1H. The write period PW consists of 480 horizontal scanning periods. During one horizontal scanning period 1H of the write period PW, an on/off operation is performed on switches included in pixel circuits PC of a row corresponding to the horizontal scanning period 1H. Switches included in pixel circuits PC of other rows are off. When this is described using potentials of wirings for supplying switch's on/off signals, the potentials supplied to a variation control switch control line HYS, a reset switch control line RES and an illumination control switch control line ILM corresponding to a given row are respectively switched between high and low levels during the horizontal scanning period 1H corresponding to the pixel circuits PC of the given row. The variation control switch control lines HYS, reset switch control lines RES and illumination control switch control lines ILM that do not correspond to that row, are respectively supplied with the potential of the low level. Writing data signals into their corresponding pixel circuits PC of 480 rows leads to the light emission period PIL, so that the light-emitting elements IL included in the respective pixel circuits PC emit light according to the data signals written into the pixel circuits PC. During the light emission period PIL, the reference potential is supplied to the corresponding data lines DATR, DATG and DATB via the integrated data line DATI. Further, the variation control switch control line HYS of each row is brought to a potential for turning on the variation control switch SWH. The illumination control switch control line ILM of each row is brought to a potential for turning on the illumination control switch SWI. The reset switch control line RES of each row is brought to a potential for turning off the reset switch SWR.

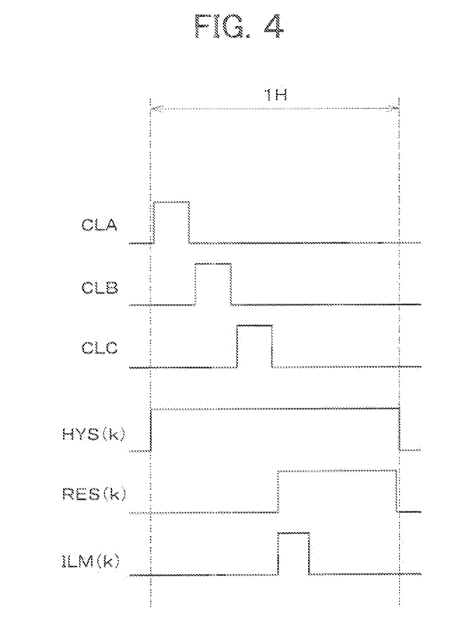

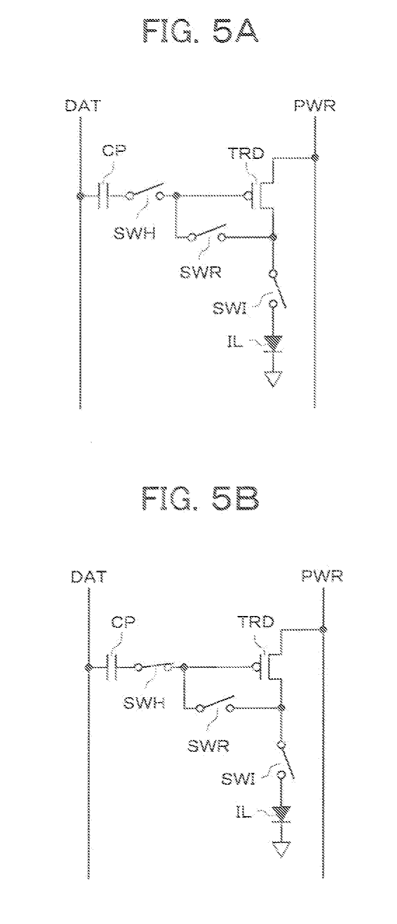

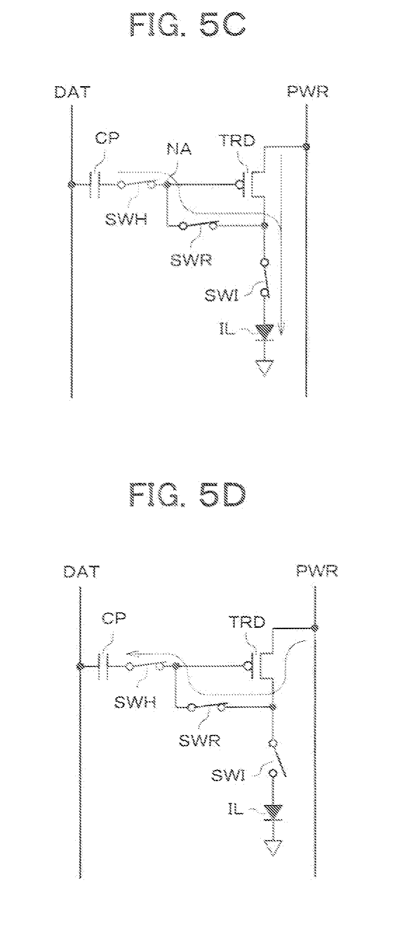

The operation of writing data signals will be described below while paying attention to pixel circuits PC of a given row. FIG. 4 is a waveform diagram showing changes in potentials of RGB changeover control lines CLA, CLB and CLC, a variation control switch control line HYS (k), a reset switch control line RES (k), and an illumination control switch control line ILM (k) during a given horizontal scanning period 1H. Here, k indicates integers from 1 to 480, and the horizontal scanning period 1H shown in the drawing corresponds to each pixel circuit PC of a kth row. FIGS. 5A through 5E are respectively diagrams showing the states of respective switches of a pixel circuit PC.

FIG. 5A is a diagram showing the states of the respective switches of the pixel circuit PC in which no data signal is written during a write period PW. Before the writing of data signals into each individual pixel circuit PC of the kth row, a potential of a low level is supplied from the vertical scanning circuit YDV to the variation control switch control line HYS (k), the reset switch control line RES (k) and the illumination control switch control line ILM (k). The variation control switch SWH, the reset switch SWR and the illumination control switch SWI included in the pixel circuit PC are respectively brought to an off state.

Next, when the horizontal scanning period 1H during which the data signal is written into each pixel circuit PC of the kth row is reached, a potential of a high level is supplied to the variation control switch control line HYS (k), so that the variation control switch SWH is turned on. The states of the individual switches of the pixel circuit at this time are shown in FIG. 5B. Next, the potential of the RGB changeover control line CLA goes from a low level to a high level, so that the integrated data line DATI is connected to its corresponding data line DATR. Then, a data signal indicative of an emitted amount of light of the pixel circuit PCR of the kth row in the column of the data line DATR is inputted to the integrated data line DATI. The potential of the data line DATR assumes the potential of the data signal. Then, the potential of the RGB changeover control line CLA is brought to a low level, and the potential of the RGB changeover control line CLB is brought to a high level, so that the destination to which the integrated data line DATI is connected changes to the data line DATG. Likewise, the potential of the data line DATG assumes a potential of a data signal indicative of an emitted amount of light of the pixel circuit PCG of the kth row. The potential of the RGB changeover control line CLC is brought to a high level instead of the RGB changeover control line CLB, so that the destination to which the integrated data line DATI is connected changes to the data line DATB. Likewise, the potential of the data line DATB assumes a potential of a data signal indicative of an emitted amount of light of the pixel circuit PCB of the kth row. The potentials of these data lines DAT are held even after the connection between the data lines DAT and the integrated data line DATI is cut off, due to parasitic capacitances developed between the data lines DAT and other wirings.

Next, the potentials of the reset switch control line RES (k) an the illumination control switch control line ILM (k) are respectively brought to a high level, so that the reset switch SWR and the illumination control switch SWI are turned on. Then, current flows from the capacitor CP to the light-emitting element IL, so that the potential of the node NA becomes low (this operation is called precharge). FIG. 5C is a diagram showing the states of the respective switches at this timing. At this time, the current flows through the light-emitting element IL, but the period during which this precharge operation is performed, is sufficiently shorter than the light emission period. The light emission of the light-emitting element IL therefore remains slight. The potential of the illumination control switch control line ILM (k) is brought to a low level after the short period, so that the illumination control switch SWI is turned off. FIG. 5D is a diagram showing the states of the respective switches at this timing. Since the potential of the node NA is first low at the timing where the illumination control switch SWI is turned off, the drive transistor TRD produces a current flow. Since, however, a difference in potential between the gate and source of the drive transistor TRD changes due to an electric charge staying at the electrode of the capacitor CP as the drive transistor TRD allows current to flow, when the difference in potential is brought to the threshold voltage Vth of the drive transistor TRD, the drive transistor TRD prevents current from flowing. On the other hand, since the data line DAT supplies the potential of the data signal stored by the parasitic capacitance to one end of the capacitor, a difference in potential occurs in the capacitor CP due to the threshold voltage Vth and the potential supplied by the data signal. Thereafter, the potential of the reset switch control line RES (k) is brought to a low level so that the reset switch SWR is turned off. Thus, the capacitor CP stores the difference in potential therein. Immediately after its operation, the variation control switch SWH is brought to an off, and hence the write operation proceeds to the writing of a data signal into each pixel circuit PC for the next row.

During a light emission period PIL, the potential of a high level is supplied to the variation control switch control line HYS and the illumination control switch control line ILM. The reference potential is supplied to the data line DAT. The light-emitting element IL included in each pixel circuit emits light according to the potential difference stored in the capacitor CP included in the pixel circuit. FIG. 5E is a diagram showing the states of the respective switches of the pixel circuit PC during the illumination period PIL. Here, the RGB changeover control lines CLA, CLB and CLC are respectively brought to a high level and hence the data lines DATR, DATG and DATB are connected to the integrated data line DATI. The data line drive circuit XDV supplies the reference potential to each data line DAT via the integrated data line DATI. Then, a potential obtained by adding the threshold voltage Vth of the drive transistor TRD based on the difference between the reference potential and the potential of a data signal is supplied between the gate and source of the drive transistor TRD, whereby the amount of current flowing to the light-emitting element is adjusted to control light emission. If the same threshold voltage Vth is taken during the writing and light emission, the drive transistor TRD causes a current corresponding to the difference between the reference potential and the potential of the data signal to flow to the light-emitting element IL regardless of the magnitude of the threshold voltage Vth thereof. The light-emitting element IL emits light with the emitted amount of light corresponding to the difference between the reference potential and the potential of the data signal.

Now it is known that the p-channel type thin film transistor like the drive transistor TRD has such a characteristic (hysteresis characteristic) that its threshold voltage Vth varies according to the history of the potential difference applied between the gate and source electrodes. This will be explained.

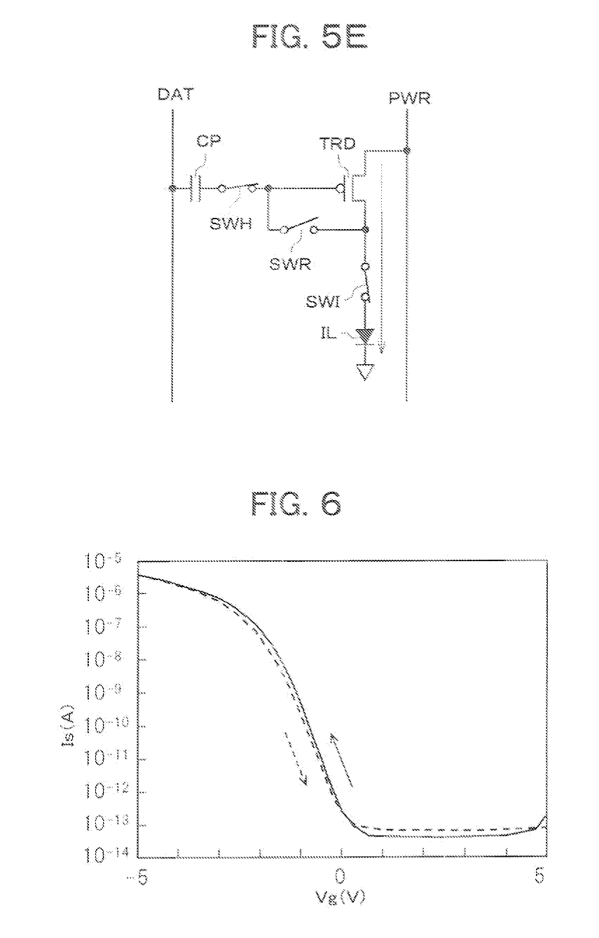

FIG. 6 is a diagram showing the hysteresis characteristic of the p-channel type thin film transistor. The threshold voltage Vth of the thin film transistor is a difference in potential (gate voltage Vg) between the gate and source thereof through which a current of a constant value or more flows. It is understood from FIG. 6 that when the gate voltage Vg is changed from plus to minus (the thin film transistor is changed from off to on), the threshold voltage Vth varies in the plus direction, whereas when the gate voltage Vg is changed from minus to plus (the thin film transistor is changed from on to off), the threshold voltage Vth varies in the minus direction.

FIG. 7 is a diagram showing a change in the amount of current with time, which flows in a case where a pulse signal is applied to the gate electrode of the p-channel type thin film transistor. This pulse signal indicates the amount of current flowing between the source and drain electrodes of the thin film transistor where a voltage close to its threshold voltage Vth is first applied, then a voltage that is in the minus direction and turns on the thin film transistor is applied for 0.1 s from a time t1 (s) to a time t2=t1+0.1 (s) (0<t1<t2<1), and thereafter a voltage close to the threshold voltage Vth is applied again. Then, the amount of current is reduced immediately after the application of a pulse than that prior to its application. When the gate voltage is held as it is, the amount of current gradually returns to the amount of current prior to the application of the pulse. As the retention time of an input pulse signal becomes longer and a change in the voltage of an input pulse becomes larger, a change in the amount of current becomes large after the application of the pulse. Incidentally, each of the hysteresis characteristics shown in FIGS. 6 and 7 is a characteristic of a transistor equivalent to the drive transistor TRD. Even though the amount of change in the current due to the hysteresis characteristic and the like differ according to a fabrication process, the threshold voltage Vth changes due to the change in the gate voltage Vg in a manner similar to the above, at least.

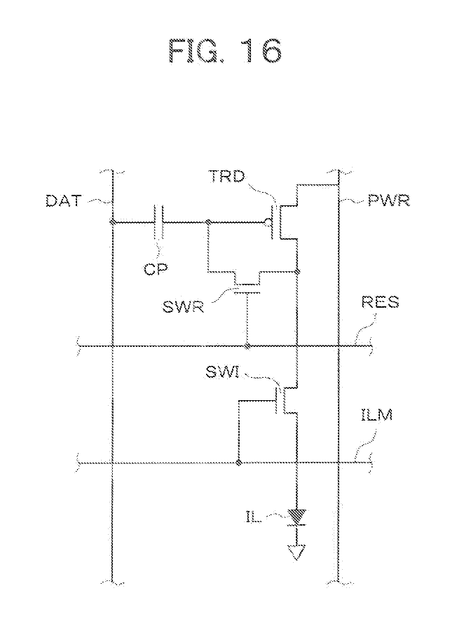

In the conventional image display device free of such a variation control switch SWH as shown in FIG. 16, the potential of the drive transistor TRD changes depending on the data signal used upon writing into each of the pixel circuits PC of other rows. An effect on the threshold voltage Vth due to its change, and an effect on a displayed image will be explained with a given display pattern as an example.

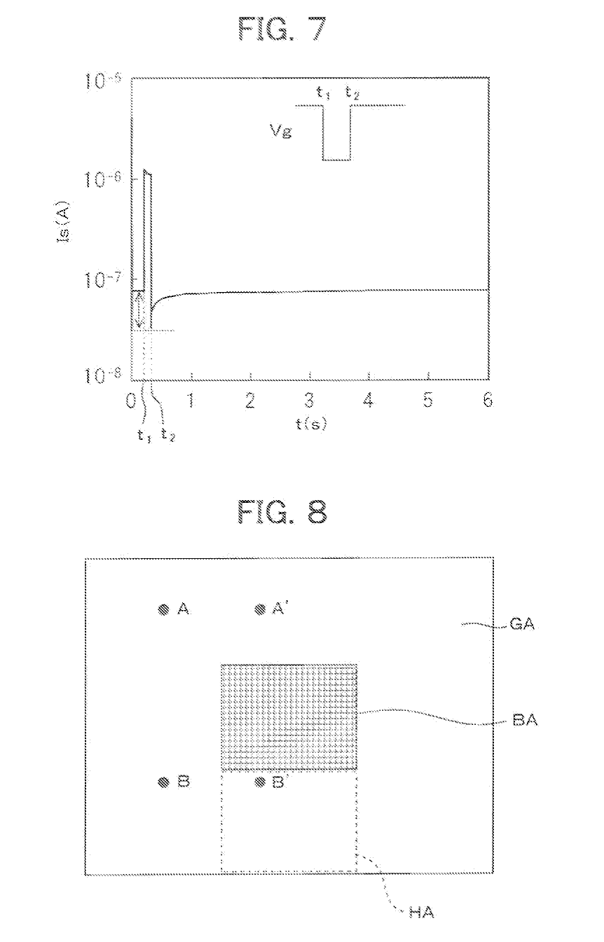

FIG. 8 is a diagram showing an example of a pattern of an image displayed by the organic EL display device. A description will be made below of a case where the writing of a data signal into each pixel circuit PC is performed in accordance with the example of the pattern. In the pattern, a rectangular black area BA exists in the center of an image to be displayed. A gray area GA is provided outside the black area BA. Points A, B, A′ and B′ on the image are respectively points on the gray area GA. The points A and B are identical in X coordinate to each other. Both of them are displayed by the pixel circuits PC connected to the same data line DAT. The points A′ and B′ are both identical in X coordinate to each other and displayed by the pixel circuits PC connected to the same data line DAT. The points A and A′ are displayed by the pixel circuits PC of the same row, and the points B and B′ are both displayed by the pixel circuits PC of the same row. The black area BA is not provided between the points A and B, whereas the black area BA is provided between the points A′ and B′. When this pattern is displayed by the conventional organic EL display device, an area displayed with brightness different from other gray areas GA in the gray area GA becomes a lower area HA.

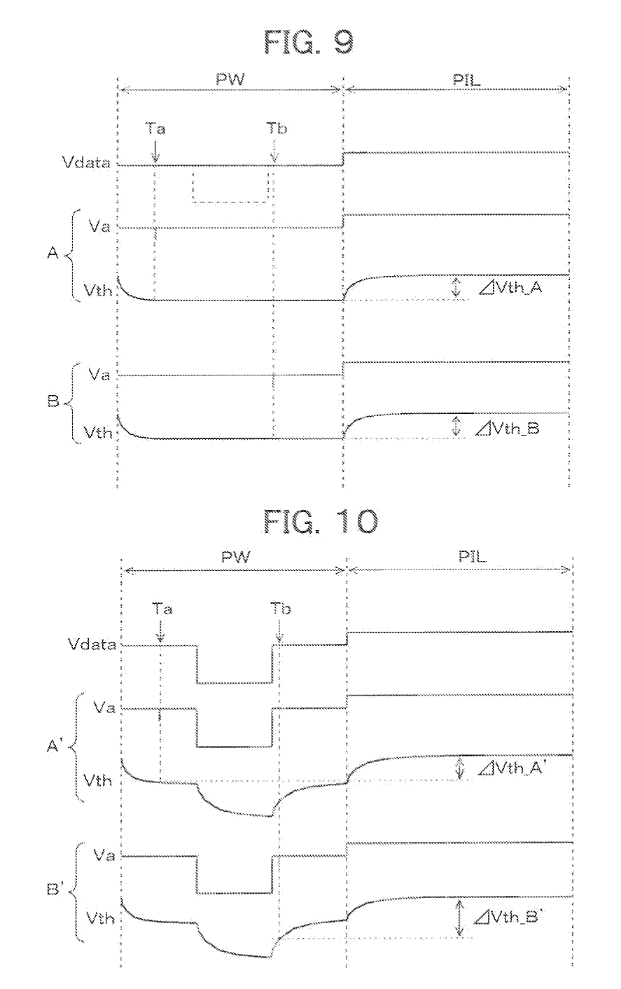

FIG. 9 is a waveform diagram showing changes in data line potential Vdata and threshold voltages Vth at the points A and B in the conventional organic EL display device. The data line potential Vdata is a potential applied to each of data lines DAT connected to the pixel circuit PC (hereinafter called pixel circuit PC of A) for displaying the point A and the pixel circuit PC (hereinafter called pixel circuit PC of B) for displaying the point B. The data line potential Vdata, the potential Va of the node NA and the threshold voltage Vth of the drive transistor TRD in the pixel circuit PC of A, and the potential Va of the node NA and the threshold voltage Vth of the drive transistor TRD in the pixel circuit PC of B are shown in the present drawing. FIG. 10 is a waveform diagram illustrating changes in data line potential Vdata and threshold voltages Vth at the points A′ and B′ in the conventional organic EL display device. The data line potential Vdata is a potential applied to each of data lines DAT connected to the pixel circuit PC (hereinafter called pixel circuit PC of A′) for displaying the point A′ and the pixel circuit PC (hereinafter called pixel circuit PC of B′) for displaying the point B′. In a manner similar to FIG. 9, the data line potential Vdata, the potential Va of the node NA and the threshold voltage Vth of the drive transistor TRD in the pixel circuit PC of A′, and the potential Va of the node NA and the threshold voltage Vth of the drive transistor TRD in the pixel circuit PC of B′ are shown.

In the conventional organic EL display device, the data line DAT and the gate electrode of each drive transistor TRD are connected via the capacitor CP even at other than the pixel circuits PC in which the data signals are written. Therefore, a change in the potential of the data line DAT becomes a change in the potential Va of the node NA as it is. Thus, when the light emission period PIL is ended and the write period PW is started, the potential Vdata of the data line DAT becomes a potential of a data signal for displaying the gray from a reference potential. Then, the threshold voltages Vth of the drive transistors TRD respectively included in the pixel circuits PC for displaying these points change in a minus direction due to the hysteresis characteristics thereof because their potentials Va become low. The potentials Va are the same potential at the pixel circuits PC of A, B, A′ and B′ until the data signal is written into the pixel circuit PC of A. Thus, a change in the threshold voltage Vth in a minus direction is also similar to the above. The capacitor CP included in the pixel circuit PC of A and the capacitor CP included in the pixel circuit PC of A′ store a potential difference corresponding to a threshold voltage Vth at a time of Ta therein with a timing of Ta. Here, the degree at which the threshold voltage Vth changes, and the potential of the applied data signal are also the same at the points A and A′. Next, since the data line potential Vdata applied to the data line DAT is constant at each of the pixel circuits PC of A and B, the threshold voltage Vth converges to a voltage corresponding to the data line potential Vdata. The capacitor CP included in the pixel circuit PC of B stores a potential difference corresponding to a threshold voltage Vth at a time of Tb therein with a timing of Tb.

On the other hand, after the writing of the data signal into the pixel circuit PC of A′, the data line potential Vdata corresponding to each of the points A′ and B′ assumes a potential for displaying the black during a period in which the data signal is written into the pixel circuit PC for displaying the black area BA. The data line potential Vdata becomes therefore lower than those in the vicinity thereof. Thus, during that period, the threshold voltage Vth of the drive transistor TRD changes in the direction of minus at each of the pixel circuits PC of A′ and B′. After that period, the data line potential Vdata assumes a potential for displaying the gray again and becomes higher. Correspondingly, the threshold voltage Vth changes in a pulse direction toward a threshold voltage Vth converging according to the data line potential Vdata of gray. Since, however, the threshold voltage is on the way back at the time of the timing Tb, the threshold voltage Vth at writing becomes a voltage lower than the voltage that converges depending on the data line potential Vdata for the gray.

Thereafter, the reference potential is supplied during the light emission period PIL, and the light emission period PIL is longer than the write period PW. For this reason, any of the threshold voltages Vth converges to the voltage corresponding to the reference potential at each of the pixel circuits PC of A, B, A′ and B′ in the course of the light emission period PIL. Here, changes in the emitted amounts of light due to the effect of hysteresis can be approximately compared according to the difference (ΔVth) between the threshold voltages Vth at the writing and the light emission period. Further, if the threshold voltage Vth at the light emission period PIL is assumed to be a threshold voltage Vth that converges to the light emission period PIL, a difference ΔVth_A in the threshold voltage Vth at the point A, and a difference ΔVth_A′ in the threshold voltage Vth at the point A′ become the same and the emitted amount of light is approximately identical. On the other hand, a difference ΔVth_B in the threshold voltage Vth at the point B, and a difference ΔVth_B′ in the threshold voltage Vth at the point B′ yield a difference. Thus, the difference in the emitted amount of light occurs between the points B and B′. The same phenomenon as that at the point B′ occurs in an area located directly below the black area BA. On the other hand, the same phenomenon as that at the point B takes place in each area not provided directly below the black area BA.

Then if viewed in the horizontal direction, the difference in the emitted amount of light is clearly shown between at the left and right ends of the lower area HA. If viewed in the horizontal direction within the lower area HA, then the same emitted amount of light appears. If viewed in the vertical direction, the lower area becomes white as it approaches the black area BA. This is because as away from the black area BA, the threshold voltage Vth at the writing into the pixel circuit PC for displaying its point approaches the threshold voltage Vth that converges at the gray, so that the difference in the emitted amount of light becomes larger (whiter) as the lower area approaches the black area, and the difference in the emitted amount of light becomes smaller (closer to the gray). Incidentally, the difference between the threshold voltages Vth due to the causes at the manufacture of the individual drive transistors TRD is canceled out by the drive method and is not recognized as the difference in the emitted amount of light.

On the other hand, in the organic EL display device according to the present embodiment, the potential of the gate electrode of the drive transistor TRD remains unchanged by the potential of the data line DAT because the variation control switch SWH is turned off when the data signal is written into each of other pixel circuits PC. Thus, changes in threshold voltages Vth become the same between the points A and A′ and the points B and B′. The phenomena in which different in the emitted amount of light occurs in the lower area HA as before do not appear. This operation will be explained more concretely.

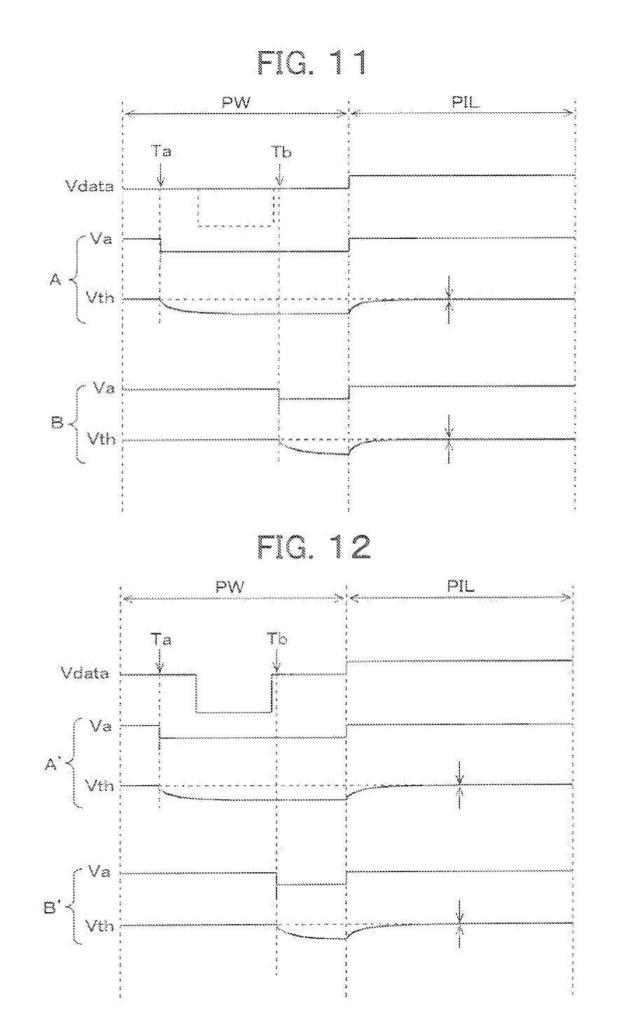

FIG. 11 is a waveform diagram showing changes in data line potential Vdata and threshold voltages Vth at the points A and B in the organic EL display device according to the embodiment of the present invention. The present drawing is a diagram corresponding to FIG. 9, and the same items are shown therein. FIG. 12 is a waveform diagram showing changes in data line potential Vdata and threshold voltages Vth at the points A′ and B′ in the organic EL display device according to the embodiment of the present invention. The present drawing is a diagram corresponding to FIG. 10, and the same items are shown therein.

In each pixel circuit PC, the variation control switch SWH is turned off before the start of a write period PW. Therefore, the potential Va of the node NA at the start of the write period PW becomes the same as the potential at a light emission or illumination period PIL. Since the potential of the node NA is maintained until a data signal is written into a pixel circuit PC including the node NA, the threshold voltage Vth at the writing becomes identical to a potential that converges during the illumination period PIL. When the writing of the data signal into the pixel circuit PC is performed, a potential Va at the writing becomes a potential corresponding to the threshold voltage Vth of a drive transistor and becomes lower than its previous one. Thereafter, the potential Va becomes low until the light emission period PIL is reached, and when the reference potential is supplied from the corresponding data line DAT during the light emission period PIL, the threshold voltage Vth converges to a voltage corresponding to the reference potential again. In the present example, the difference in potential at the convergence of the threshold voltage Vth does not occur between upon writing and at the light emission period PIL. Since the period from the execution of writing to the emission of light differs depending on the row of the pixel circuits PC strictly, the threshold voltages Vth at the start of the light emission period PIL differ from each other. Thus, the difference between the emitted amounts of light due to pixels occurs but does not occur between the pixel circuits PC of the same row. For this reason, the difference in the emitted amount of light is not recognized at the left and right ends of the lower area HA.

Incidentally, while it is of a phenomenon that is not taken into consideration in FIGS. 11 and 12, the difference in the emitted amount of light may be reduced by parasitic capacitances. The variation control switch SWH is a thin film transistor. A parasitic capacitance occurs between a wiring for its gate electrode and a wiring for either its source or gate electrode, which is connected to a gate electrode of a drive transistor. Thus, as the case may be, there occurs a phenomenon that when the variation control switch SWH is turned off, the potential of the node NA becomes low, whereas when the variation control switch SWH is turned on, the potential becomes high by the same amount as that when the potential is reduced. This phenomenon is called filed through herein. When the field through takes place, there occurs the effect of matching the threshold voltage Vth with a voltage corresponding to the phenomenon during a period from the execution of writing to the start of the light emission period PIL. It is thus possible to more suppress sudden fluctuations in the threshold voltage Vth.

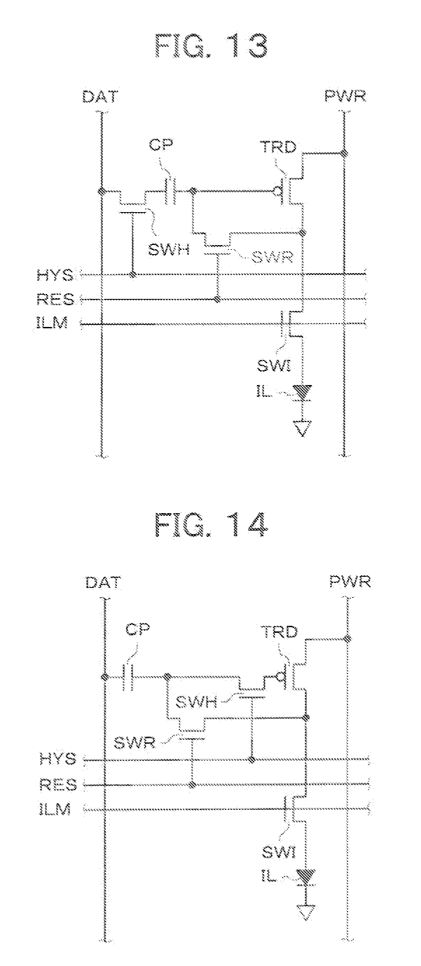

Incidentally, the configuration of the pixel circuit PC is not limited to one shown in FIG. 1. FIG. 13 is a diagram showing another example of a pixel circuit PC of the organic EL display device according to the embodiment of the present invention. Each pixel circuit PC includes a light-emitting element IL, a drive transistor TRD, a capacitor CP, an illumination control switch SWI, a reset switch SWR, and a variation control switch SWH. A reference potential is supplied to one end of the light-emitting element IL by an unillustrated reference potential supply wiring. One end of the variation control switch SWH is connected to its corresponding data line DAT corresponding to this pixel circuit PC, and the other end thereof is connected to one end of the capacitor CP. The other end of the capacitor CP is connected to its corresponding gate electrode of the drive transistor TRD. A source electrode of the drive transistor TRD is connected to a power supply line PWR, and a drain electrode thereof is connected to one end of the illumination control switch SWI. The other end of the illumination control switch SWI is connected to the other end of the light-emitting element IL. The gate and drain electrodes of the drive transistor TRD are connected to each other via the reset switch SWR. Since a method of driving the pixel circuit PC is similar to the control on each of the pixel circuits PC shown in FIG. 1, the description thereof is omitted. Even in the case of the pixel circuit PC shown in the present drawing, a change in the difference in the threshold voltage Vth can be suppressed in a manner similar to one shown in FIG. 1.

FIG. 14 is a diagram illustrating a further example of a pixel circuit PC of the organic EL display device according to the embodiment of the present invention. Each pixel circuit PC includes a light-emitting element IL, a drive transistor TRD, a capacitor CP, an illumination control switch SWI, a reset switch SWR, and a variation control switch SWH. A reference potential is supplied to one end of the light-emitting element IL by an unillustrated reference potential supply wiring. One end of the capacitor CP is connected to its corresponding data line DAT corresponding to this pixel circuit PC. A gate electrode of the drive transistor TRD is connected to the other end of the capacitor CP via the variation control switch SWH. A source electrode of the drive transistor TRD is connected to a power supply line PWR, and a drain electrode thereof is connected to one end of the illumination control switch SWI. The other end of the illumination control switch SWI is connected to the other end of the light-emitting element IL. The other end of the capacitor CP and the drain electrode of the drive transistor TRD are connected to each other via the reset switch SWR. Even in the case of the pixel circuit PC shown in the present drawing, a change in the difference in the threshold voltage Vth can be suppressed in a manner similar to one shown in FIG. 1.

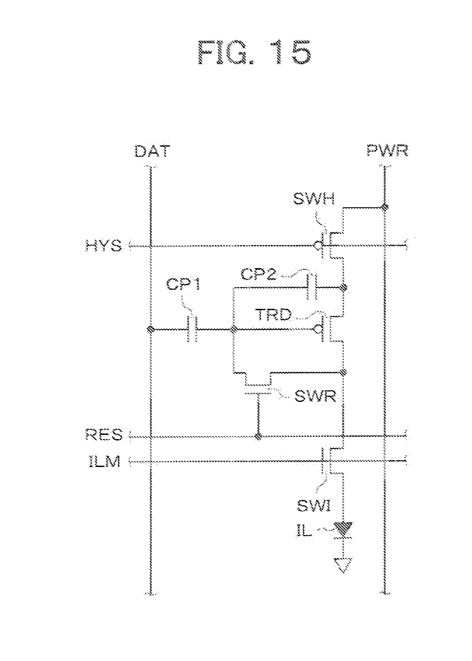

FIG. 15 is a diagram showing a still further example of a pixel circuit PC of the organic EL display device according to the embodiment of the present invention. Each pixel circuit PC includes a light-emitting element IL, a drive transistor TRD, a first capacitor CP1, a second capacitor CP2, an illumination control switch SWI, a reset switch SWR, and a variation control switch SWH. One end of the light-emitting element IL is supplied with a reference potential by an unillustrated reference potential supply wiring. One end of the first capacitor CP1 is connected to its corresponding data line DAT. A gate electrode of the drive transistor TRD is connected to the other end of the first capacitor CP1. The illumination control switch SWI has one end connected to the other end of the light-emitting element IL, and the other end connected to a drain electrode of the drive transistor TRD. The reset switch SWR has one end connected to the gate electrode of the drive transistor TRD, and the other end connected to the drain electrode of the drive transistor TRD. The second capacitor CP2 has one end connected to the gate electrode of the drive transistor TRD, and the other end connected to a source electrode of the drive transistor TRD. The variation control switch SWH has one end connected to a power supply line PWR, and the other end connected to the source electrode of the drive transistor TRD. In the example of the present drawing, the variation control switch SWH serves as a p-channel type thin film transistor. While the timing provided to turn on/off each switch is similar to the above example, the relationship between high and low levels of a potential supplied to a variation control switch control line HYS is placed in reverse because the variation control switch SWH is of a p-channel type. In the example of the present drawing, as an alternative to the switch for cutting off between the data line DAT and the drive transistor TRD, the source electrode of the drive transistor TRD is caused to float to store a difference in potential between the gate and source electrodes of the drive transistor TRD, whereby a fluctuation in the threshold voltage Vth due to the potential of the data line DAT is suppressed. Even in this case, an advantageous effect similar to the example described in FIG. 1 and the like is obtained. Incidentally, in the example of the present drawing, there is no need to connect the drain electrode of the variation control switch SWH and the gate electrode of the drive transistor TRD. Since it is not necessary to connect wirings formed in different layers of gate and drain electrodes, the degree of freedom of a layout becomes high as compared with other examples.

What is claimed is:

1. An image display device comprising:
data lines each supplying a data signal; and
a plurality of pixel circuits,
each of the plurality of pixel circuits including:
a light-emitting element;
a capacitor which stores a difference in potential caused by the data signal therein;
a drive transistor which has a gate electrode connected to the data line via the capacitor and controls light emission of the light-emitting element based on a difference in potential between the gate electrode and a source electrode thereof, the difference in potential being caused by a potential supplied by the data line and the potential difference stored in the capacitor; and
a variation control switch which causes the difference in potential between the gate and source electrodes of the drive transistor to vary based on the data signal at the turning on thereof and prevents the difference in potential from varying at the turning off thereof.

2. The image display device according to claim 1,
wherein the variation control switch and the capacitor both included in each of the pixel circuits are disposed in series between the data line and the gate electrode of the drive transistor included in the pixel circuit.

3. The image display device according to claim 2,
wherein the gate electrode of the drive transistor and the capacitor both included in each of the pixel circuits are connected to each other via the variation control switch included in the pixel circuit.

4. The image display device according to claim 1,
wherein the data line supplies a potential for light emission to each of the gate electrodes of the drive transistors included in the pixel circuits during a light emission period different from a period for supplying the data signal for causing each of the capacitors included in the pixel circuits to store the difference in potential, and
wherein the drive transistor included in each of the pixel circuits controls light emission of the light-emitting element included in each of the pixel circuits, based on the difference in potential between the gate and source electrodes thereof, the difference in potential being caused by the potential for light emission and the potential difference stored in the capacitor.

5. The image display device according to claim 2,
wherein the gate electrode of the drive transistor and the variation control switch both included in each of the pixel circuits are connected to each other via the capacitor included in the pixel circuit.

6. The image display device according to claim 1,
wherein one end of the variation control switch included in each of the pixel circuits is connected to the source electrode of the drive transistor, the other end of the variation control switch being supplied with a power supply potential.

7. An image display device comprising:
data lines each supplying a data signal; and
a plurality of pixel circuits,
each of the plurality of pixel circuits including:
a light-emitting element,
a capacitor which has one end connected to the data line and stores a difference in potential caused by the data signal therein,
a variation control switch having one end connected to the other end of the capacitor,
a drive transistor which has a gate electrode connected to the other end of the variation control switch and performs control on light emission of the light-emitting element based on a potential supplied by the data line and the potential difference stored in the capacitor,
an illumination control switch having one end connected to one end of the light-emitting element and the other end connected to a drain electrode of the drive transistor, and
a reset switch having one end connected to the gate electrode of the drive transistor and the other end connected to the drain electrode of the drive transistor.

8. An image display device comprising:
data lines each supplying a data signal;
a plurality of pixel circuits; and
a power supply line,
each of the plurality of pixel circuits including:
a light-emitting element,
a first capacitor which has one end connected to the data line and stores a difference in potential caused by the data signal therein,
a drive transistor which has a gate electrode connected to the other end of the first capacitor and performs control on light emission of the light-emitting element based on a potential supplied by the data line and the potential difference stored in the first capacitor,
an illumination control switch having one end connected to one end of the light-emitting element and the other end connected to a drain electrode of the drive transistor,
a reset switch having one end connected to the gate electrode of the drive transistor and the other end connected to the drain electrode of the drive transistor,
a second capacitor which has one end connected to the gate electrode of the drive transistor and the other end connected to a source electrode of the drive transistor, the second capacitor storing a difference in potential caused by the data signal therein, and
a variation control switch having one end connected to a power supply line and the other end connected to the source electrode of the drive transistor.
